(19) United States
(12) Patent Application Publication
(10) Pub. No.: US 2002/0187871 A1
(43) Pub. Date: Dec. 12, 2002

(54) Hub assembly with speed change

(75) Inventors: Xiaolan Ai, Massillon, OH (US); Terry W. Mohr, Canton, OH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timken Company

(21) Appl. No.: 09/853,534

(22) Filed: May 11, 2001

(51) Int. Cl. F16H 13/06

(52) U.S. Cl. 475/197

(57) ABSTRACT

A hub assembly, which accommodates rotation about an axis with a change in angular velocity, includes a carrier that is attached to a supporting structure, a shaft having a pair of sun rollers located in the carrier, a hub having a pair of rings, each surrounding a different sun roller, and planet rollers arranged in two rows between the sun rollers and the rings. The sun rollers have tapered raceways, as do the rings, and the planet rollers have tapered side faces along which they contact the raceways. The carrier has axles about which the planet rollers rotate, with each axle supporting a roller of each row. These rollers bear against each other at beveled end faces such the rollers on each axle back each other. Each roller contains an antifriction bearing which enable it to revolve on its axle and transfer radially and/or axially directed loads to the carrier.

### BACKGROUND OF THE INVENTION

This invention relates in general to hub assemblies and more particularly to a hub assembly which accommodates rotation about an axis with a change in angular velocity.

Some vehicles rely on electric motors to power their wheels, and these motors are typically located at the wheels themselves—one for each driven wheel. But the wheels often require torques of large magnitude to rotate them. To reduce the torque demands, the wheel assemblies often include speed-reducing devices, and they may take the form of planetary gear drives.

Such wheel assemblies are not altogether satisfactory. First they are complex, with some of the complexity residing in the co-existence of gear drives and antifriction bearings which transfer the weight of the vehicle chassis to the wheels. In this regard, the planetary gears do not have the capacity to transfer radial loads themselves. Moreover, gear drives generate noise and consume energy inasmuch as the teeth of the gears, where they mesh, slide over each other. Also gear drives require oil lubrication, which is difficult to provide at the remote locations of the wheels.

### SUMMARY OF THE INVENTION

The present invention resides in a hub assembly for supporting radial and axial loads and for effecting a change in angular velocity about an axis of rotation. The hub assembly has a carrier that is capable of being secured to a supporting structure, a shaft located within the carrier, and a hub located around the carrier. The shaft defines first and second inner tapered raceways and the hub defines first and second outer tapered raceways. Planet rollers are arranged in two rows between the inner raceways that are carried by the shaft and the outer raceways that are carried by the hub. The planet rollers revolve on axles that form part of the carrier, and can include bearings to facilitate rotation of the planet rollers about the axles and to transfer loads from the hub to the carrier. The hub assembly preferably includes sun rollers on the shaft. The inner tapered raceways are preferably defined by the sun rollers.

A rotating item, such as a vehicle wheel, is mounted to the hub. In operation, rotation of the shaft causes the sun rollers to rotate; frictional engagement of the sun rollers with the planet rollers then causes the planet rollers to rotate about the axles; and frictional engagement of the planet rollers with the hub causes the hub to rotate about the shaft. The hub assembly thus forms a friction or traction drive which drives, for example, a vehicle wheel mounted to the hub, and at the same time, provides speed reduction between the rotational speed of the shaft and the rotational speed of the hub.

### DESCRIPTION OF THE DRAWINGS

FIG. 1 is an exploded perspective view of a hub assembly constructed in accordance with and embodying the present invention together with a wheel that is mounted on the hub assembly;

FIG. 2 is a longitudinal sectional view of the hub assembly;

FIG. 3 is a transverse sectional view of the hub assembly taken along line 3-3 of FIG. 2;

FIG. 4 is a fragmentary perspective view, exploded, of the center shaft forming part of the hub assembly;

FIG. 5 is a half-sectional view of the hub assembly showing the envelopes of surfaces along which frictional contact exits;

FIG. 6 is a longitudinal sectional view of a modified hub assembly that includes an electric motor or a generator;

FIG. 7 is a fragmentary view, partly in cross-section, of an alternative ramp-loading mechanism;

FIG. 8 is a cross-sectional view of a second alternative hub assembly in which rolling element bearings are incorporated into planetary rollers of the hub assembly; and

FIG. 9 is an enlarged fragmentary sectional view taken at the circle 9-9 of FIG. 8.

### DETAILED DESCRIPTION

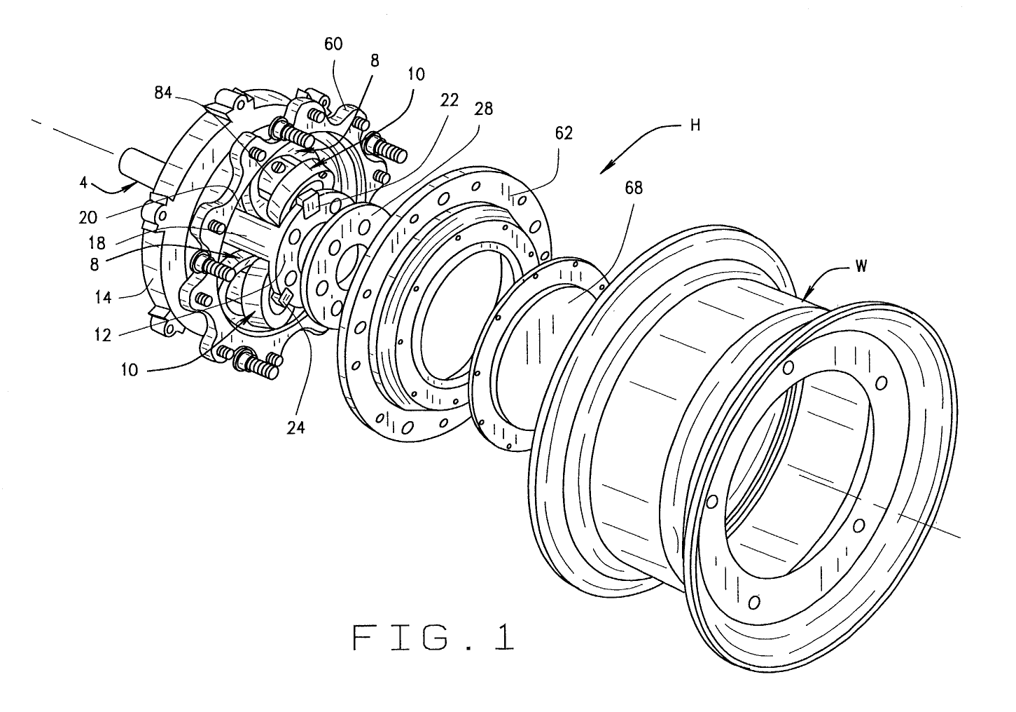

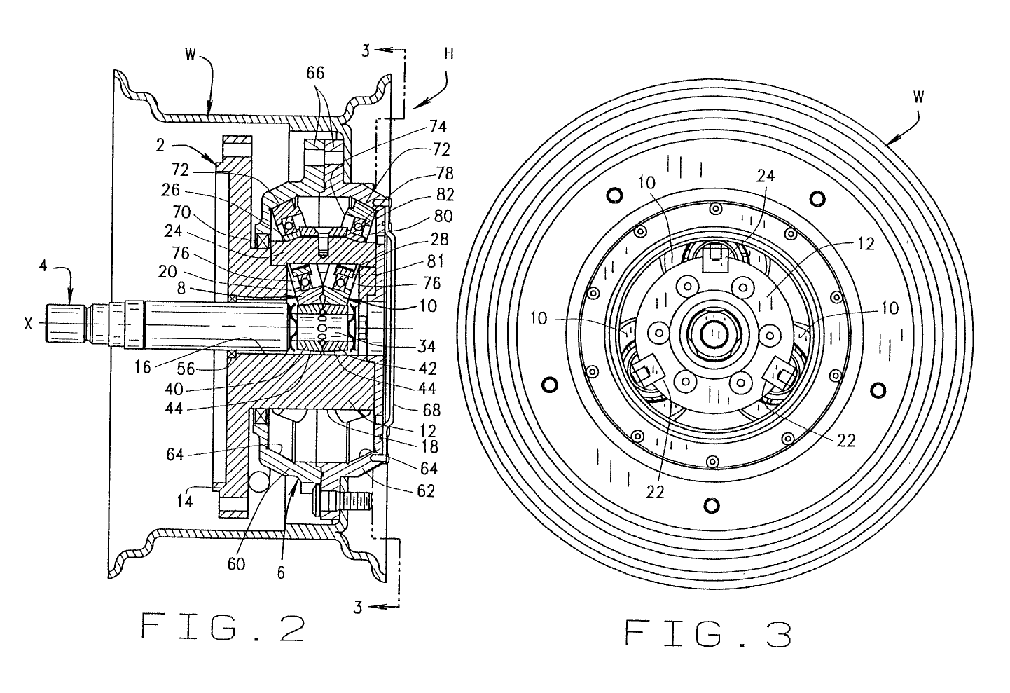

Referring now to the drawings, a hub assembly H (FIGS. 1 and 2) couples a vehicular wheel W to the suspension system of an automotive vehicle. In addition, it transfers torque to the wheel W, so that the wheel W will rotate and propel the vehicle. That torque derives from an internal combustion engine, or other prime mover, and may be transferred to the hub assembly H through shafts or through an electric motor. Where the former exists, the hub assembly H is attached directly to the suspension system of the vehicle, whereas in the latter it may be attached indirectly to the electric motor. The hub assembly H provides an axis X about which the wheel W rotates. Not only does the hub assembly H confine the wheel radially with respect to the axis X, but it also prevents the wheel W from being displaced axially in either direction along the axis X.

The hub assembly H includes (FIGS. 1 and 2) a carrier 2 which is mounted on a component (not shown) of the suspension system of the vehicle. It also has a center shaft 4 which extends into and rotates in the carrier about the axis X. In addition, the carrier 2 has a hub 6 which rotates around the axis X and planet rollers 8 and 10 which are organized in two rows between the interior of the hub 6 and the exterior of the shaft 4. The planet rollers 8 and 10 transfer torque from the center shaft 4 to the hub 6 and in so doing enable the hub 6 to rotate around the axis X, although at a reduced angular velocity.

The carrier 2 has (FIG. 2) a spindle 12 and a flange 14 formed integral with the spindle 12 at one end of the spindle 12. It also has a central bore 16 which extends completely through it along the axis X, opening at one end out of the flange 14 at its other end out of the free end of the spindle 12. Between that free end and the flange 14 the spindle 12 has a cylindrical exterior surface 18 (FIGS. 1 and 2) which is interrupted by three roller cavities 20 that open into the bore 16 as well as out of the surface 18. In the embodiment shown, the cavities 20, which are spaced at equal circumferential intervals, occupy more of the exterior of the spindle 12 than the cylindrical surface 18. However, depending on the size of the cavities 20 and the circumference of the spindle 12, the ratio of the exterior surface of the spindle to the cavity can change. The cylindrical surface 18 completely surrounds the spindle 12 beyond the ends of the cavities 20, leaving the ends of the cavities 20 offset from the flange 14 and from the end face at the free end of the spindle 12 as well. In these end regions the spindle 12 has notches 22 which are centered midway between the sides of the cavities 20, there being a pair of notches 22 for each cavity 20.

The carrier 2 also includes (FIG. 2) roller axles 24 which bridge the cavities 20 midway between the sides of the cavities 20, there being a separate axle 24 for each cavity 20. The ends of the axles 24 fit into the notches 22 that open out of the cylindrical surface 18 of the spindle 12, so that the notches 22 confine the axles 24. Each axle 24 possesses a generally rectangular cross section and has two convex bearing seats 26, which taper downwardly away from each other. Finally, the carrier 2, against the end face at its free end, has a retaining plate 28 which is secured with machine screws and extends over the ends of the three axles 24, thereby trapping the axles 24, at least axially, in the notches 22.

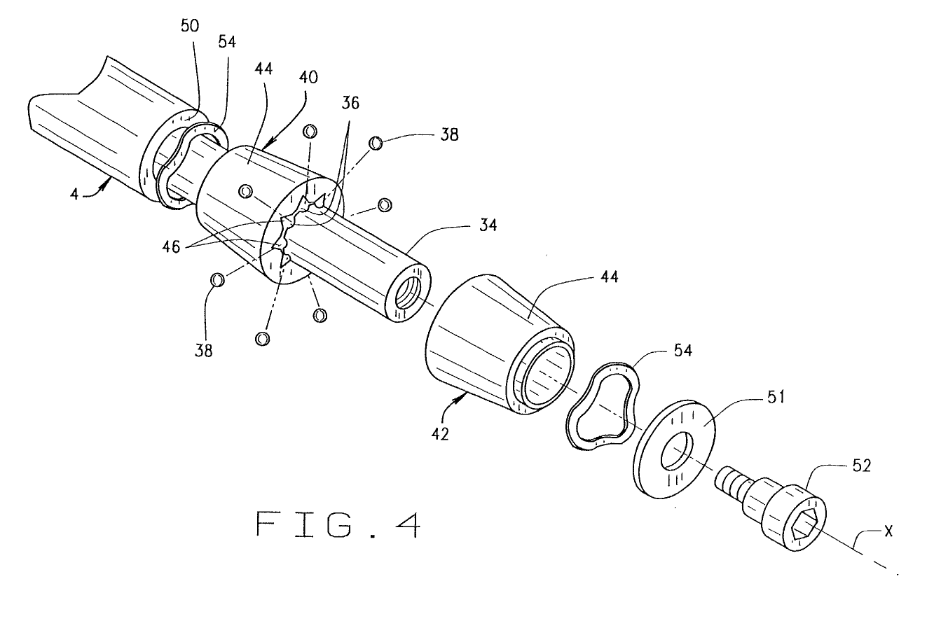

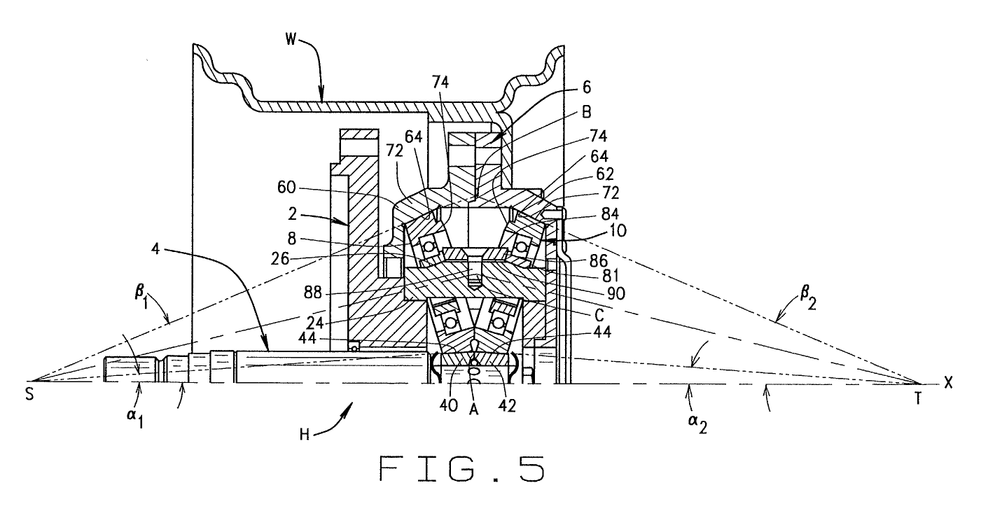

The center shaft 4 extends into the central bore 16 of carrier 2 from the end on which the flange 14 is formed and it terminates within the spindle 12 (FIG. 2). In the region of the cavities 20, the shaft 4 itself is provided with a spindle 34 having (FIG. 4) slightly elliptical sockets 36 opening out of it generally midway between its ends. The sockets 36 are arranged at equal circumferential intervals around the spindle 34 with their major axes extending parallel to the axis X. The sockets 36 contain balls 38.

The shaft 4 includes(FIGS. 2 and 4) two sun rollers 40 and 42 which are fitted to its spindle 34, each having a tapered raceway 44 that is presented outwardly away from the axis X, with the two raceways 44 tapering downwardly away from each other so the two rollers 40 and 42 have their greatest diameters where they are closest. The rollers 40 and 42 fit loosely enough over the spindle 34 to rotate and move axially on the spindle 34, but these motions are for the most part limited by the balls 38 that are in the sockets 36 of the spindle 34. To this end, the two sun rollers 40 and 42 have (FIG. 4) sockets 46 which open out of their closely spaced end edges that are along the spindle 34 and which receive the balls 38. The sockets 46 are preferably formed by a V-shaped cuter. The balls 38 key the two rollers 40 and 42 to the spindle 34, so that the rollers 40 and 42 rotate as part of the drive shaft 4, to which they are fitted.

The spindle 34 projects from a shoulder 50 (FIG. 4) on the shaft 4, and at its other end has a machine screw 52 threaded into it. The rollers 40 and 42 are captured between the shoulder 50 and a flat washer 51 which is secured in place by the machine screw 52. The rollers 40 and 42 are urged together by wave washers 54, one being between shoulder 50 and the end of the roller 40 and the other being between the washer 51 and the end of the roller 42. When the balls 38 transfer torque between the spindle 34 and the rollers 40 and 42, the rollers 40 and 42 are urged apart against the bias of the two wave washers 54, this being a consequence of the camming action of the balls 38 moving along the surfaces of the sockets 36 and 46.

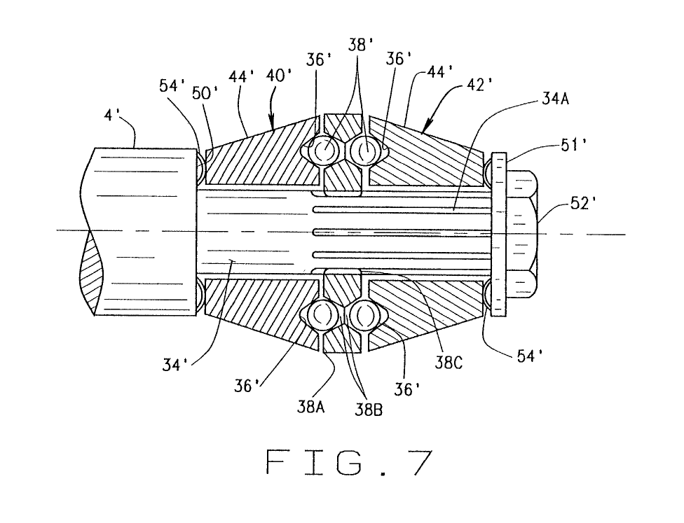

Another ramp-loading mechanism is shown in FIG. 7. In this ramp-loading mechanism, a spindle 34′ extends from a shaft 4′. The spindle 34′ includes a plurality of axially extending grooves 34A which extend rearwardly from the free end of the spindle. The spindle 34′ is smaller in diameter than the shaft 4′, and the two, in combination, define a shoulder 50′, against which a wave washer 54′ is positioned. A pair of sun rollers 40′ and 42′ are journaled on the spindle 34′ to be rotatable about the spindle. The rollers 40′ and 42′ are tapered rollers and define raceways 44′ on their outer surfaces. The rollers are positioned such that their wider diameter ends face each other. The rollers 40′ and 42′ include sockets 36′ which receive balls 38′. The balls 38′ are spaced from the spindle 34′, and are held in position by a ball cage 38A. The ball cage 38A has sockets 38B which are aligned with the roller sockets 36′. The ball cage 38A includes ribs 38C which mate with the spindle grooves 34A to rotationally fix the ball cage 38A to the spindle 34′. Hence, the ball cage 38A will not rotate relative to the spindle 34′. A second wave washer 54′ is placed against the smaller diameter face of the roller 42′. A washer 51′ is placed against the wave washer 54′, and a bolt 52′ is threaded into the end of the spindle 34′ to hold the ramp-loading mechanism or assembly together.

Where the center shaft 4 emerges from the carrier 2, that is on the backside of the flange 14, the carrier is fitted with a seal 56 (FIG. 2) which establishes a barrier along the shaft 4.

The hub 6 encircles the spindle 12 on the carrier 2 and has (FIGS. 1 and 2) two rings 60 and 62 which are held together with machine screws. Each ring 60 and 62 has a raceway 64 (FIG. 2) which is presented inwardly toward the axis X, and although the two raceways 64 are spaced apart, they tapered radially inwardly and away from each other. Thus, the raceways 64 define the largest diameter toward the center of the hub 6, where the two raceways are closest together. Conversely, the raceways 64 define the smallest diameter at the outer ends of the raceways, where the raceways 64 are farthest apart. The raceway 64 on the ring 60 is presented toward the raceway 44 on the sun roller 40, whereas the raceway 64 on the ring 62 is presented toward the raceway 44 on the sun roller 42. The conical envelopes formed by the raceways 44 and 64 for the sun roller 40 and ring 60 have their apecies at a common point S (FIG. 5) along the axis X. Likewise the conical envelopes formed by the raceways 44 and 64 on the rollers 42 and 62 have their apecies at another common point T along the axis X.

The two rings 60 and 62 abut each other along flanges 66 (FIG. 2), and here they are held firmly together with machine screws. The wheel W is attached to the flange 66 of the ring 62 with lug bolts and hence rotates with the hub 6.

The hub 6 also includes an end cap 68 (FIGS. 1 and 2) which is attached to the ring 62 to close the otherwise open end of the ring 62 and thereby isolate the interior of the hub 6, the sun rollers 40 and 42, and the planet rollers 8 and 10 from contaminants. At the opposite end of the hub 6, which is next to the flange 14 on the carrier 2, the ring 60 carries a seal 70 (FIG. 2) which establishes a barrier around the cylindrical surface 18 of the spindle 12.

The planet rollers 8 and 10 revolve about the axles 24 of the carrier 2 without undergoing any orbital motion, the rollers 8 being organized in one row between the sun roller 40 and the ring 60 and the rollers 10 being organized in another row between the sun roller 42 and the ring 62. Each roller 8 and 10 has (FIG. 2) a tapered side face 72 and a beveled end face 74. Each contains an antifriction bearing 76 having an outer race 78 fitted to the interior of the roller 8 or 10, an inner race 80 fitted over a sleeve 81 which is fitted over the axle 24 for the roller 8 or 10, and rolling elements 82 arranged in a single row between two races 78 and 80. The sleeve 81 has a cylindrical exterior surface and a rectangular interior bore. The interior of the sleeve 81 conforms generally to the generally rectangular cross section of the axle 24 over which it is fitted. To this end, the sleeve 81 has four flat interior surfaces, three of which lie along the flat sides of the axle 24, and a cylindrical exterior surface end which conforms to the inner race 80 of the bearing 76. The bearings 76 enable the rollers 8 and 10 to transfer both radial and axial loads to the axles 24 at the inclined bearing seats 26 on the axles. Each axle 24 supports a single planet roller 8 and a single planet roller 10, with their end faces 74 presented toward and contacting each other. The rollers 8 and 10 that are on an axle 24 form a set or pair.

The planet rollers 8 along their tapered side faces 72 contact the raceways 44 and 64 of the sun roller 40 and ring 60, respectively, there being line contact (FIG. 5). Thus, the rollers 8 are on apex, meaning that the conical envelopes formed by their tapered side faces 72 have their apices at the common point S along the axis X shared by the conical envelopes for the raceway 44 and 64 between which the rollers 8 are located. This produces pure rolling contact between the rollers 8 and the raceways 44 and 64 between which they are located, that is to say contact which is characterized by the absence of spinning along the lines of contact.

Likewise, the rollers 10 along their side faces 72 contact the raceways 44 and 64 of the sun roller 42 and ring 62, respectively, there again being line contact (FIG. 5). Hence, the rollers 10 are on apex, and as such the envelopes formed by their conical side faces 72 have their apices at the point T along the axis X shared by the apices of the envelopes for the raceways 44 and 64 between which the rollers 10 are located. This produces pure rolling contact between the rollers 10 and the raceways 44 and 64 of the sun roller 42 and ring 62.

The pair of planet rollers 8 and 10 on each axle 24 contact each other along their beveled end faces 74 and here line contact exists as well (FIG. 5). Moreover, the contact lies along a straight line that connects the point A of intersection for the envelopes for the two inner raceways 44, the point B of intersection for the envelopes for the two outer raceways 64, and the point C of intersection for the axes of the two rollers 8 and 10. That connecting line also intersects the axis X. The tapered geometry of the rollers 8 and the raceways 44 and 64 along which they are located prevents the rollers 8 from moving down the raceways 44 and 64 and away from the rollers 10. Likewise the tapered geometry of the rollers 10 and the raceways 44 and 64 between which they are located prevents them from moving down their raceways 44 and 64 and away from the rollers 8. Since the rollers 8 and 10 on any axle 24 contact each other along their beveled end faces 74, the rollers 8 and 10 cannot move up their respective raceways 44 and 64 either. In other words, the rollers 8 back the rollers 10, and the rollers 10 back the rollers 8. In effect, the rollers 8 are captured between the raceways 44 and 64 of the sun roller 40 and ring 60, in the sense that they cannot be displaced axially, and likewise the rollers 10 are captured between the raceways 44 and 64 of the sun roller 42 and ring 62 in the sense that the rollers 10 cannot be displaced axially.

To insure that the inner races 80 for the bearings 76 do not migrate up their tapered seats 26 on the axles 24, each axle 24 is fitted with a spacer 84 (FIG. 5) in the region between its two bearing seats 26. Each spacer 84 has end faces 86 which are beveled such that they lie perpendicular to the tapered bearing seats 26. The spacer 84 is attached to its axle 24 with a machine screw 88, and between the spacer 84 and the axle 24 lies a shim 90. The thickness of the shim 90 determines the spacing between the inner races 80 of the two bearings 76.

When the hub assembly H is installed on an automotive vehicle, the flange 14 of the carrier 2 is secured with bolts to the suspension system of the vehicle. The wheel W of course has a pneumatic tire fitted to it and that tire contacts a road surface. The center shaft 4 is coupled to a motor, whether it be an electric motor or an internal combustion engine. That motor exerts torque on the drive shaft 4, causing the shaft 4 to rotate.

The sun rollers 40 and 42, being keyed to the spindle 34 of the drive shaft 4 by the balls 38, rotate with the shaft 4. In so doing, they exert torque on the planet rollers 8 and 10, inasmuch as the sun rollers 40 and 42 along their raceways 44 contact the planet rollers 8 and 10 along their tapered side faces 72. The friction between the raceways 44 and the tapered side faces 72 is enough to impart rotation to the planet rollers 8 and 10, with primarily pure rolling contact existing at the lines of contact between the raceways 44 of the rollers 40 and 42 and the tapered side faces 72 of the planet rollers 8 and 10, that is to say contact characterized by the absence of spinning at the line of contact.

The balls 38 key the two sun rollers 40 and 42 to the spindle 34 of the center shaft 4 and transfer the torque from the spindle 34 to the sun rollers 40 and 42. In so doing, the balls 38 bear against the sides of the ball holding sockets 46 in the sun rollers 40 and 42, and since the sides of these sockets 46 are somewhat oblique to the opposed end faces of the sun rollers 40 and 42, a camming action develops which urges the sun rollers 40 and 42 apart. This drives the raceways 44 of the sun rollers 40 and 42 tightly against the tapered side faces 72 of the planet rollers 8 and 10 and lodges the planet rollers 8 and 10 tightly between the sun rollers 40 and 42 and the rings 60 and 62. Thus, the tapered side faces 72 of the planet rollers 8 and 10 bear tightly against the tapered raceways 64 on the rings 60 and 62. The rotating planet rollers 8 and 10 impart rotation to the two rings 60 and 62 of the hub 6. Pure rolling contact likewise exists at the lines of contact between the tapered side faces of the planet rollers 8 and 10 and the raceways 64 of the rings 60 and 62, that is to say contact characterized by the absence of spinning at the lines of contact. The hub 6 rotates and turns the wheel W, propelling the vehicle.

The bearings 76 enable the planet rollers 8 and 10 to rotate on the axles 24, and the axles 24 serve to position the planet rollers 8 and 10 between the sun rollers 40 and 42 and the rings 60 and 62 at equal circumferential intervals. Aside from preventing the planet rollers 8 and 10 from migrating, the bearings 76 also carry loads directed radially and/or axially toward the axis X.

As the planet rollers 8 and 10 on each axle 24 rotate, they roll against each other at their beveled end faces 74. The contact between the end faces 74 for any set of planet rollers lies along a line which passes through the point A of intersection of the envelopes formed by the raceways 44, the point B of intersection for the envelopes formed by the raceways 64, and the point C of intersection of the axis of the two rollers 8 and 10 (FIG. 5). The result is pure rolling contact, characterized by the absence of spinning, at the line of contact. While their tapered geometry prevents the planet rollers 8 and 10 from moving down the raceways 44 and 64 along which they roll, the rollers 8 and 10 of each axle 24 back each other and thus are prevented from moving up their raceways 44 and 64.

The planet rollers 8 and 10 serve to transfer torque between drive shaft 4 and the hub 6, with a reduction in angular velocity and a corresponding increase in torque. In this sense the planet rollers 8 and 10 serve as idlers. The speed ratio K becomes

$$K = \frac{sin {β}_{1}}{sin {α}_{1}} = \frac{sin {β}_{2}}{sin {α}_{2}}$$

where α₁, and α₂ are the half angles of the envelopes for the raceways 44 on the sun rollers 40 and 42, and β₁ and β₂ are the half angles of the envelopes for the raceways 64 on the rings 60 and 62.

The rollers 8 and 10 serve to transfer the weight of the vehicle to the wheel W. In this regard, the vertical force represented by the load at the suspension system component is transmitted to the rollers 8 and 10 at the axles 24 that are below the axis X, with the transfer being through the bearings 76 on those axles 24, and the rollers 8 and 10 in turn transfer it to the hub 6.

The hub assembly H has applications beyond the automotive field. For example, it may be used to transfer the rotation of the vanes of a windmill to an electrical generator to harness wind to produce electrical energy. In that application, the vanes are coupled to the hub 6, whereas the center shaft 4 drives the electrical generator at an angular velocity greater than that of the hub 6.

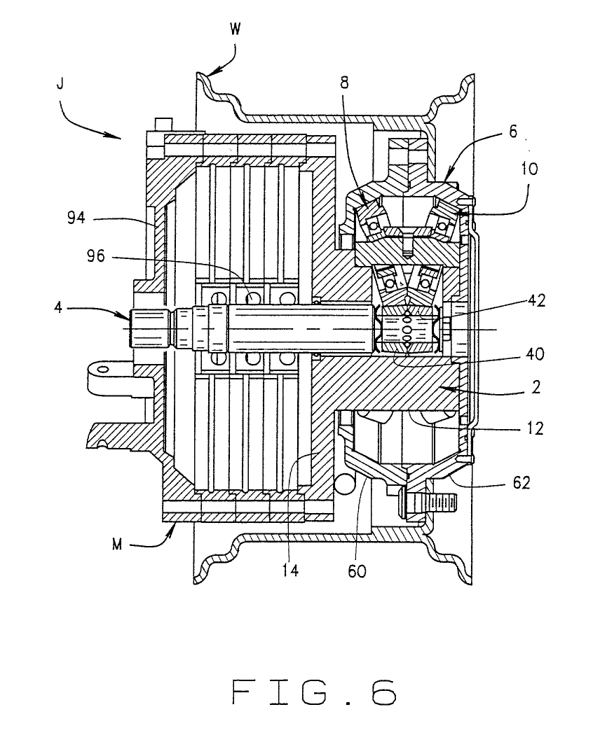

A modified hub assembly J (FIG. 6) includes an electric motor M having a housing 94 and an armature 96. The flange 14 on the carrier 2 forms one end of the housing 94. The center shaft 4 extends into the housing 94 and supports the armature 96. The magnetic field developed by field windings in the motor M rotates the armature 96 which, being on the shaft 4, rotates the shaft 4. The hub 6 and wheel W rotate at a lesser velocity.

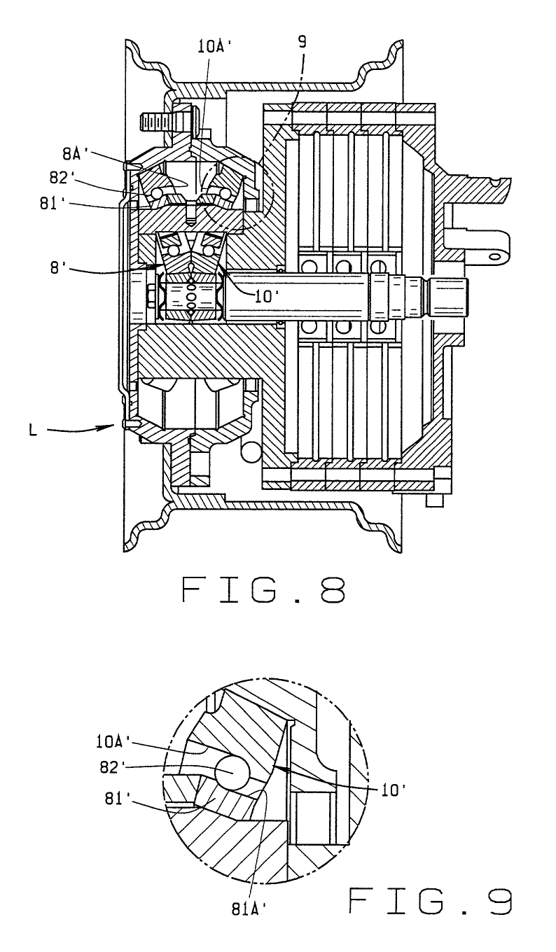

Another modified hub assembly L is shown in FIG. 8. The hub assembly L has integrated planetary rollers 8′ and 10′. The rolling element bearings 76 of the hub H (FIG. 2) are eliminated. Rather, inner surface 8A′ and 10A′ of the rollers 8′ and 10′, respectively, define outer raceways for the rolling elements 82′; and the outer surface 81A′ of the sleeve 81′ defines the inner raceway for rolling element 82′. Thus, effectively, the outer race 78 of the bearing 76 has been integrated with the rollers 8 and 10; and the inner race 80 has been integrated with the sleeve 81. As can be appreciated, by eliminating the bearings 76 from the hub H, and incorporating them into the rolling elements 8′ and 10′, as in the hub L, assembly costs for the hub are reduced. Additionally, tolerance stack-ups, which result from assembling discrete parts, are reduced.

As various changes could be made in the above constructions without departing from the scope of the invention, it is intended that all matter contained in the above description or shown in the accompanying drawings shall be interpreted as illustrative and not in a limiting sense.

What is claimed is:

1. A hub assembly for supporting radial and axial loads and for effecting a change in angular velocity about an axis of rotation, said hub assembly comprising: a carrier having axles arranged around the axis and extending generally axially; a center shaft located along the axis and carrying first and second inner raceways that are tapered and are presented outwardly away from the axis; a hub surrounding the shaft and having first and second outer raceways that are tapered and presented inwardly toward the first and second inner raceways, respectively of the center shaft; first planet rollers located around the axles and between the first raceways and having side faces where they contact the first raceways; second planet rollers located around the axles and between the second raceways and having side faces where they contact the second raceways.

2. The hub assembly according to claim 1 wherein the first raceways taper downwardly toward the axis in the same direction, and the second raceways taper downwardly toward the axis in the same direction and in the direction opposite to that in which the first raceways taper.

3. The hub assembly according to claim 2 wherein each of the raceways has a large end; and wherein the first and second inner raceways are closest at their large ends and the first and second outer raceways are closest at their large ends.

4. The hub assembly according to claim 1 where each axle has a first and a second planet roller around it.

5. The hub assembly according to claim 4 wherein the first and second planet rollers have end faces, and the first and second planet rollers around each axle contact each other at their end faces.

6. The hub assembly according to claim 5 wherein pure rolling contact exists between the side faces of first rollers and the first raceways, between the side faces of the second rollers and second raceways, and between the end faces of the first and second rollers around each axle.

7. The hub assembly according to claim 1 including bearings located between the rollers and the axles for transferring radial loads between the carrier and rollers.

8. The hub assembly according to claim 7 wherein the bearings around at least one of the axles are configured to carry loads directed radially with respect to the axis.

9. The hub assembly according to claim 1 wherein the carrier has a flange and a spindle projecting from the flange; wherein the hub is located around the spindle; and wherein the axles are carried by the spindle.

10. In combination with a supporting structure, a hub assembly for facilitating rotation about an axis that is fixed in position with respect to the supporting structure, said hub assembly comprising: a carrier attached securely to the supporting structure and including axles extending generally axially and arranged around the axis; a center shaft located within said carrier and carrying first and second inner raceways which are presented outwardly away from the axis and tapered downwardly away from each other so that the inner raceways are closest where they have their greatest diameters; a hub located around the axles of the carrier and having first and second outer raceways which taper downwardly away from each other so that the first and second outer raceways are closest where they have their greatest diameters, the first outer raceway being presented toward the first inner raceway and the second outer raceway being presented toward the second inner raceway; first planet rollers located around the axles and between the first raceways, each first roller having a tapered side face where it contacts the first raceways and an end face generally at the large end of its tapered side face; second planet rollers located around the axles between the second raceways, each second roller having a tapered side face where it contacts the second raceways and an end face generally at the large end of its side face; there being around each axle a first planet roller and a second planet roller, with the first and second rollers around each axle contacting each other at their end faces; the rollers being rotatable relative to the axles to transfer between the rollers and the axles loads that are directed radially or axially with respect to the axis whereby both the shaft and hub will rotate about the axis, with the shaft rotating at a velocity greater than the hub.

11. The combination according to claim 10 including bearings located between the axles and the rollers.

12. The combination according to claim 10 wherein the shaft has a spindle located within the carrier and further includes first and second sun rollers located around the spindle, with the first inner raceway being on the first sun roller and the second inner raceway being on the second inner raceway.

13. The combination according to claim 12 wherein the spindle of the shaft contains sockets that open outwardly away from the axis, and the sun rollers have sockets that open toward the sockets in the spindle; and wherein the shaft further comprises elements located in the sockets of the spindle and the sockets of the sun rollers to key the rollers to the shaft, the elements and sockets further being configured to effect a camming action that urges the sun rollers apart when torque is transmitted between the sun rollers and the spindle.

14. The combination according to claim 10 wherein the hub comprises first and second rings on which the first and second outer raceways are located, respectively.

15. The combination according to claim 10 wherein the carrier has a flange at which the carrier is attached to the supporting structure and a spindle projecting from the flange with the axles being on the spindle of the carrier.

16. The combination according to claim 15 wherein the spindle of the carrier has cavities in which the rollers are located.

17. The combination according to claim 10 wherein the axles have bearing seats, and the bearings have inner races which fit around the seats and rolling elements which are located around the inner races and within the rollers, the inner races being against the axles at the bearing seat to transfer loads from the planet rollers to the axles.

18. The combination according to claim 17 wherein the inner races and the axles are configured to enable the inner races to rock with respect to the axles so that the rollers seek a correct orientation between their first and second raceways.

19. The combination according to claim 10 and further comprising a road wheel attached securely to the hub.

20. The combination according to claim 10 and further comprising an electric motor interposed between the carrier of the hub assembly and the supporting structure; and wherein the shaft extends through the motor and is rotated by the motor.

21. The combination according to claim 10 wherein the planetary rollers are bearings, the rollers including roller inner races and roller outer races and rolling elements positioned between the roller inner and outer races.
